(19) United States
(12) Patent Application Publication
(10) Pub. No.: US 2013/0197938 A1
(43) Pub. Date: Aug. 1, 2013

(54) SYSTEM AND METHOD FOR CREATING AND USING HEALTH DATA RECORD

(71) Applicants: Yousef Bayouk, Irvine, CA (US); Ashok Chennuru, Powell, OH (US); Rickey Tang, Southwick, MA (US); Sean J. Hickman, Glastonbury, CT (US); Omar Latif, Los Angeles, CA (US)

(72) Inventors: Yousef Bayouk, Irvine, CA (US); Ashok Chennuru, Powell, OH (US); Rickey Tang, Southwick, MA (US); Sean J. Hickman, Glastonbury, CT (US); Omar Latif, Los Angeles, CA (US)

(73) Assignee: WELLPOINT, INC., Chicago, IL (US)

(21) Appl. No.: 13/592,861

(22) Filed: Aug. 23, 2012

Related U.S. Application Data
(60) Provisional application No. 61/528,087, filed on Aug. 26, 2011.

(51) Int. Cl. G06F 19/00

(52) U.S. Cl. CPC G06F 19/322
USPC 705/3

(57) ABSTRACT

Systems, methods and computer-readable media for creating and using a health data record. Data relating to a patient's health is received from one or more information sources. The data includes unstructured data and structured data elements. The unstructured data is parsed to identify data elements. At least some of the structured data elements and at least some of the data elements parsed from the unstructured data are normalized to create normalized data elements. A weight is assigned to the normalized data elements. The normalized data elements are mapped in accordance with an ontology. The mapped data is stored in a data repository in accordance with a data model.

### CROSS REFERENCE TO RELATED APPLICATIONS

This application claims priority to U.S. Provisional Patent Application No. 61/528,087, filed Aug. 26, 2011, the entirety of which is incorporated herein by reference.

### FIELD OF THE INVENTION

The systems and methods described herein relate to creation and subsequent use of a health data record.

### SUMMARY OF EMBODIMENTS OF THE INVENTION

The present invention is directed to systems, methods and computer-readable media for creating and using a health data record. Data relating to a patient's health is received from one or more information sources. The data includes unstructured data and structured data elements. The unstructured data is parsed, using one or more dictionaries, to identify data elements. At least some of the structured data elements and at least some of the data elements parsed from the unstructured data are normalized to create normalized data elements. The normalized data elements are assigned a weight. The normalized data elements are mapped in accordance with ontology. The mapped data is stored in a data repository in accordance with a data model. The data model associates the patient to a patient record. The patient record includes data describing third parties associated with providing healthcare for the patient; health condition information of the patient, including health condition timeline information for the patient; medication information for the patient; lifestyle information for the patient; health service information for the patient; health encounter information for the patient; and medical measure data for the patient.

In some embodiments, as part of the mapping process, a time sequence of the data is determined.

Some embodiments of the invention further include receiving data reflecting a health service, health encounter or health condition of the patient; and comparing the received data to existing data in the patient record for the patient to determine a diagnosis or proposed course of action.

In some embodiments, upon determining the diagnosis or the proposed course of action, one or more of the dictionaries are updated with content reflecting the diagnosis or the proposed course of action.

Some embodiments of the invention include receiving data reflecting a plurality of health services performed for the patient; and determining whether any of the plurality of health services are associated with a same health condition of the patient based on the data stored in accordance with the data model.

The normalized data elements may include, in some embodiments, normalized diagnostic codes; normalized clinical terms; and/or normalized units of measure.

The weightings may be based on an identity of information source; passage of time between when the received data is originated and when the received data is received; and/or relevance of to another ontology.

### BRIEF DESCRIPTION OF THE DRAWINGS

FIGS. 1A and 1B are exemplary ontologies that may be used in connection with the present invention;

FIG. 2 is a diagram illustrating an exemplary system of the present invention;

FIGS. 3A, 3B and 3C are flow diagrams illustrating an exemplary methods for carrying out an embodiment of the present invention;

FIGS. 4A and 4B illustrate different views of an exemplary logical data model that may be used in connection with the present invention; and

FIG. 5 is a system diagram illustrating exemplary computer hardware and software components that may be used in connection with an embodiment of the present invention.

### DETAILED DESCRIPTION

The systems and methods described herein allow for patient data from multiple sources to be integrated and aggregated into a single, patient-centered record. In one embodiment, the record captures past, present and future patient data, including as the patient switches providers or visits different providers. The data that is collected is not limited to a given provider or payor and, instead, is obtained from different providers for members of each payor. Collected data includes administrative, laboratory, radiology, pharmacy, and clinical data, by way of example. Administrative data can include claims data and member demographic data. Demographic data can also include data purchased from external sources. Unstructured, clinical data (e.g., doctor's notes or free-form text in HL-7 messages) is parsed and codified for inclusion in the record. The record also may include data captured from remote diagnostic monitoring devices. The system may also derive enriched data from the base data sourced from the various systems. Sources are evaluated for importance, reliability and quality in connection with constructing the record and weightings are assigned accordingly. Data included in the record for a patient may be tracked using a unique identifier.

Data inputs are normalized and semantically represented in a database using an ontology. Ontology refers to the way concepts, such as disease, treatments, and people, are represented in the patient record. Generally speaking, an ontology represents the concepts of a domain, the relationships between these concepts (e.g., classifications), the vocabulary used to designate them, and their definition (informal and/or formal). The classification relationship plays a central role, as it provides the skeleton (which may, but need not necessarily be, a tree-like structure) of an ontology. In the context of the present invention, the ontology is a purpose-built representation of the information useful for the continuing care of patients, including the relationships among the many different types of information and knowledge that are needed to deliver a useful and usable system. It provides the ability to organize and filter information around concepts of clinical importance, such as a disease state or a clinical specialty, rather than, for example, around the kind of test or the department in which it was performed.

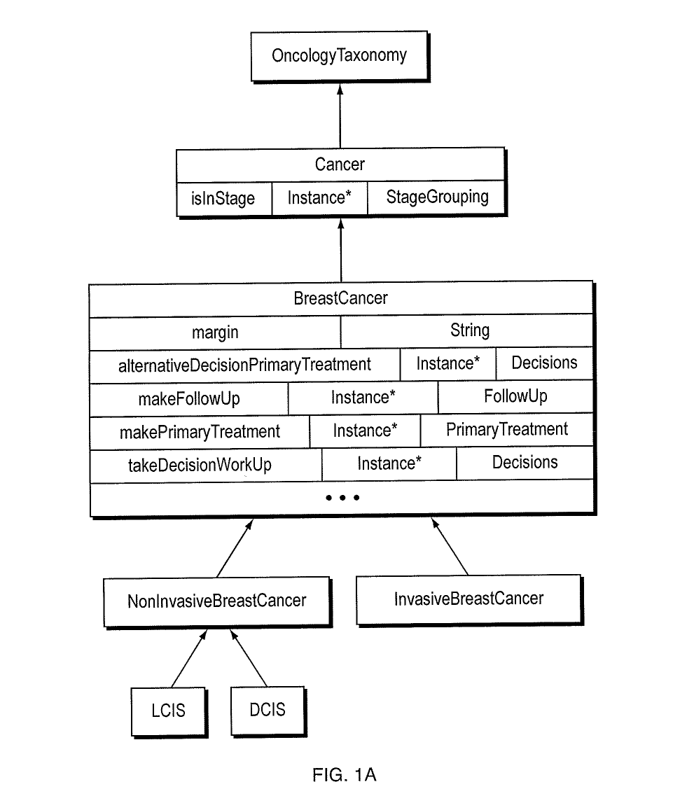

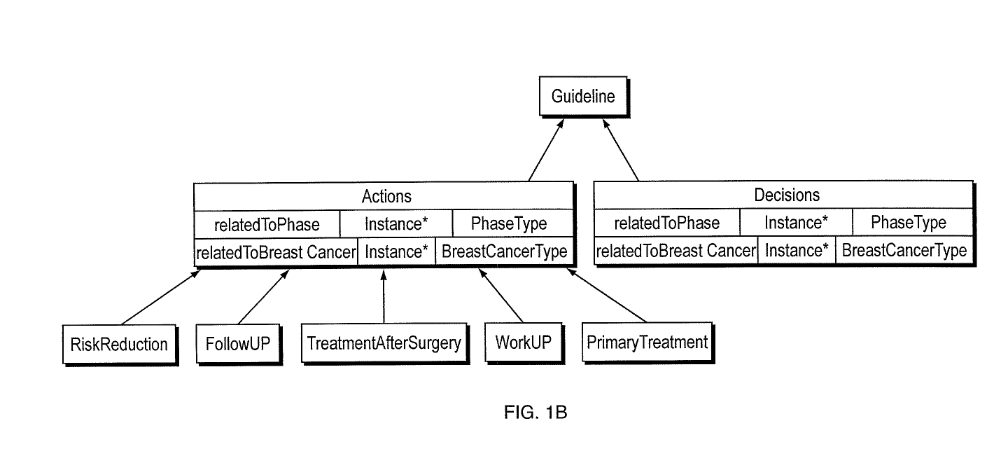

The basic notions useful in connection with building ontologies are concepts, relations, vocabulary and definitions. The following example introduces the notions of concepts and relationships, and illustrates the terminological aspects of ontologies. FIG. 1A provides an illustrative example of a conceptual ontology structure for Breast Cancer. FIG. 1B provides an illustrative example of a conceptual oncology structure in the treatment and guidelines for breast cancer. Thus, for example, using an ontology for Breast Cancer, it could be established that

Breast radiation therapy is classified as a breast cancer treatment

Breast surgery is classified as a breast cancer treatment

Mastectomy is classified as breast surgery

Other, non-classification, relationships can also be established using the ontology, for example:

Mastectomy Can_be_realized_ with lymph node removal

Mastectomy Can_be_followed_by breast radiation therapy

Lymph node removal Can_cause lymphedema of arm

The classification relationship provides the skeleton of the Ontology (its taxonomic part), while other relationships provide information about the domain that can be exploited through logical reasoning (e.g., for information retrieval or question-answering purposes).

Several different terms can be used in the same language to designate a concept, e.g., mastectomy, mammectomy and breast removal can all be used for the concept “mastectomy”. These terms can be considered as synonyms and any of them could be used to designate the concept mastectomy. However, it is common usage to choose a preferred term among these synonyms, in order to facilitate the communication between the different users of the ontology.

In one exemplary embodiment, the ontology supports multi-faceted information retrieval. For example, it is established that patients' query formulations lead to poor results. It is likely that a patient will search for “heart attack” rather than “myocardial infarction”, “rash” rather than “ex-anthema” or “hair loss” rather than “alopecia”. Therefore, for example, breast cancer terminology for users of the system should contain terms specific to the patients' language, such as “breast pain” for “mastodynia” and “breast removal” for “mastectomy”, but also medical terms such as “pyrexia”, which they can encounter. Through an ontology with a rich terminology in a given domain, users of the system will be able to access and understand health-related data and knowledge in the particular field, while using their own words and language. In order that access to web-based medical content be independent from the language and the scientific skill of the user, an ontology associated with a multilingual terminology may be used to index and query documents. Such an information retrieval system can also be used by health professionals, as their language may also be employed in the indexing process, through the concept-based indexing approach that is applied.

The patient record provides a rich understanding of the patient's health and care, across providers and over time, thereby supporting a person-centric model of health management and health care. In particular, the patient record is based on a model of care that is built around the individual, rather than a specific institution such as a hospital or lab. It can form the basis for presentations of information and the active management of care across providers and over time. Data inputs can be incorporated into an existing health care event or form a new one, as applicable; this creates a concise set of health care events that give users a clear picture of the patient. The systems and methods allow for rationalizing to a single event from multiple, potentially duplicative data elements and services.

The patient record allows all stakeholders that are involved in the care of each patient (including the patient) to work out of the same record based on their roles and authorization levels. This capability allows physicians, care managers and other authorized users to view and apply the health record as part of the care process, e.g., in connection with diagnosis or treatment.

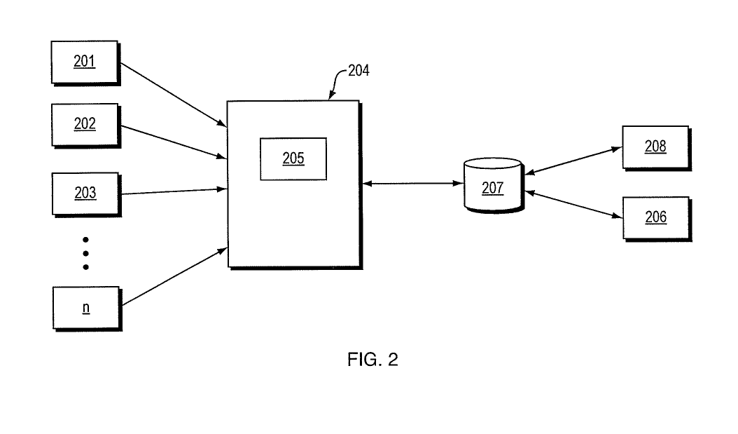

FIG. 2 is a diagram illustrating an exemplary system for carrying out one embodiment of the present invention.

Data is received from a plurality of different source systems 201, 202, 203 . . . n. The data may be input directly by providers, e.g., using Internet portlets; may come from regional or national health information exchanges; or may come from data aggregators. The system supports a number of different technical communication standards that may be used by the source systems for transmitting data, in the exemplary embodiment, including, e.g., ANSI X.12; 237-238; 270-271; and ANSI HL-7. Still further, the system also supports a variety of different Web Standards, such as the following examples: JSR-168; JSR-170; JSR-238; and WSRP. Proprietary standards may also be supported.

The data received may include eligibility, claims or medical management information from payors; admission, discharge, transfer or lab data from hospitals; clinical data, such as notes, decisions, diagnoses, problem lists or visit histories; and provider data such as lab results, referrals, medications, or medication compliance information.

Data items are received at computer system 204. Computer system 204 includes connectivity services that handle both inbound and outbound data exchanged with source systems in the form of a message. The system uses a cross-platform interface engine as a key component of its transformation process. A connectivity configuration manager stores configuration data and manages the deployment environments. The platform monitors and manages the connectivity runtime components, including the connectivity designer used to define the specific message handling processes, connectivity adapters, and the runtime engine.

In the exemplary embodiment, each message, regardless of source, is processed in the manner described below. This results in a patient record in which all included data in the record is comparable to other data contained in the patient record, as well as to data in other patients' records, and, still further, to guidelines and protocols of the payor or other interested entity.

Upon receipt of a message from a source system, integration component 205 processes the message. In particular, the data in the message is parsed into discrete fields and is transformed to a transaction standard based on the message type designated in the source system message. If source system messages are not received in transaction standard form, this step transforms the source message received to the standard.

The health information exchange supports implementation standards for various healthcare data exchange transactions including Health Level Seven (HL7), HIPPA required ANSI X12, and National Council of Prescription Drug Programs (NCPDP). This approach often allows an already extant data feed to be used to populate the patient record. For example, an HL-7 Result Message currently being generated for exchange between a Laboratory System and an EMR System can also be used to populate the patient record with often few, if any, changes to the message.

It must then be determined whether the entity associated with the data or message is known to the system. During the identity matching process, entity (e.g., person and organization) data is evaluated using matching criteria to determine whether the entity is already known to the system and, therefore, whether the information should be added to an existing record or whether a new record should be created. This is performed by integration component 205. When a match is detected, the new information event is filed into the record of the person who is the subject of the event (e.g., patient, member, employee). If a match is not found, then a new record is created and the information event is attached to the newly created patient record. The references to the other persons (e.g., physician, subscriber, guarantor, next of kin) and organizations related to this person are likewise evaluated using the matching criteria (i.e., determine if there is a reference to an existing person or organization or, if no match, a new person or organization record is created).

At this point, in one embodiment, the record is placed in persistent storage 207.

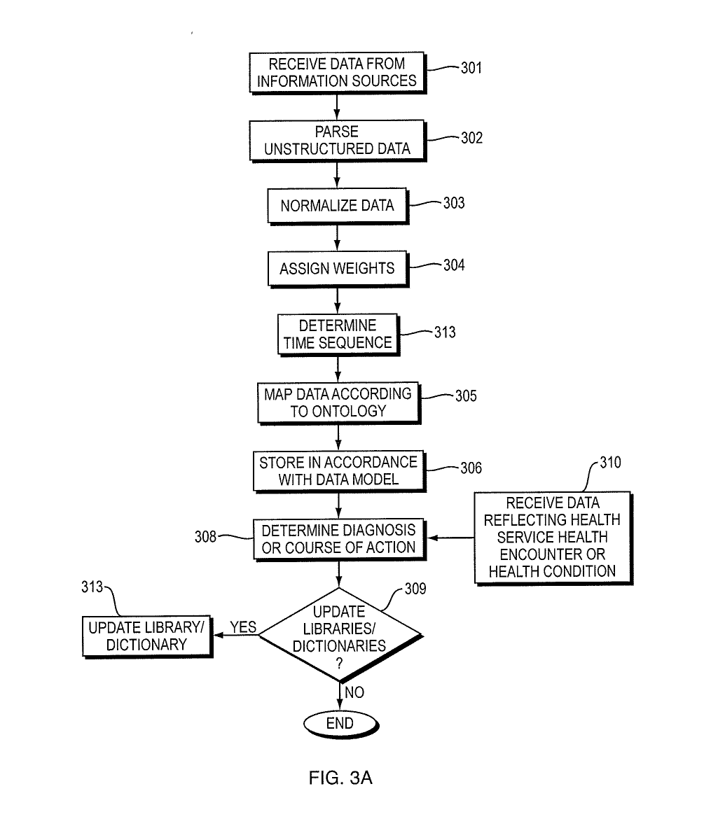

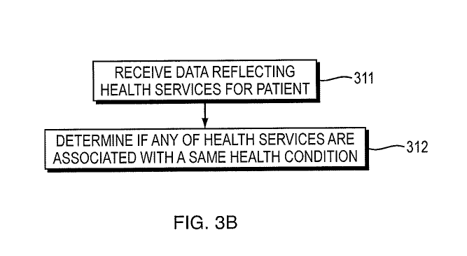

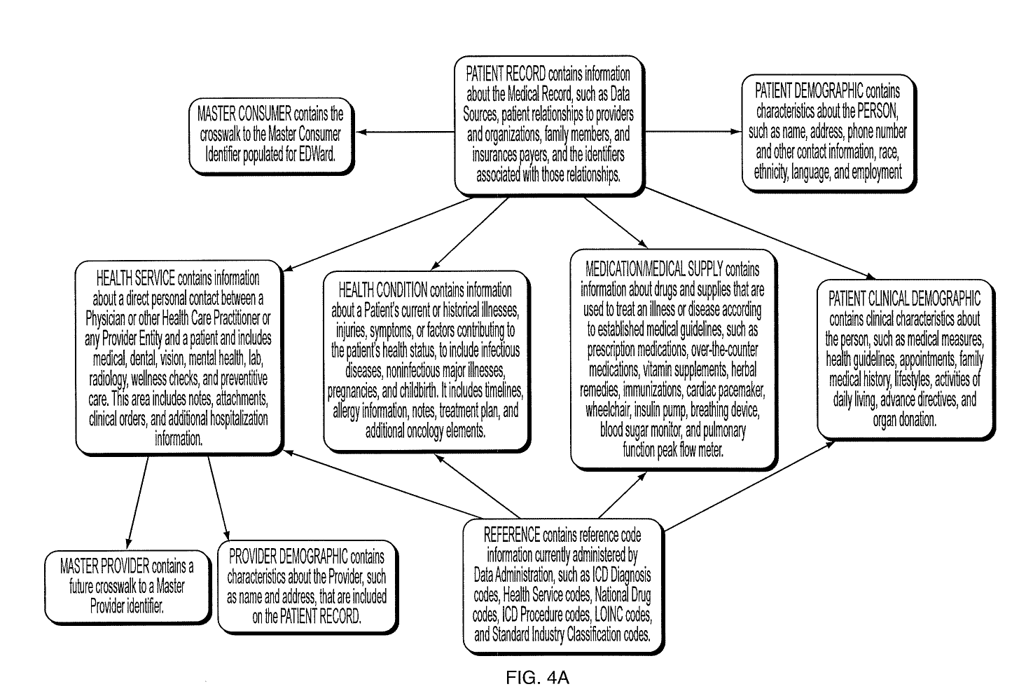

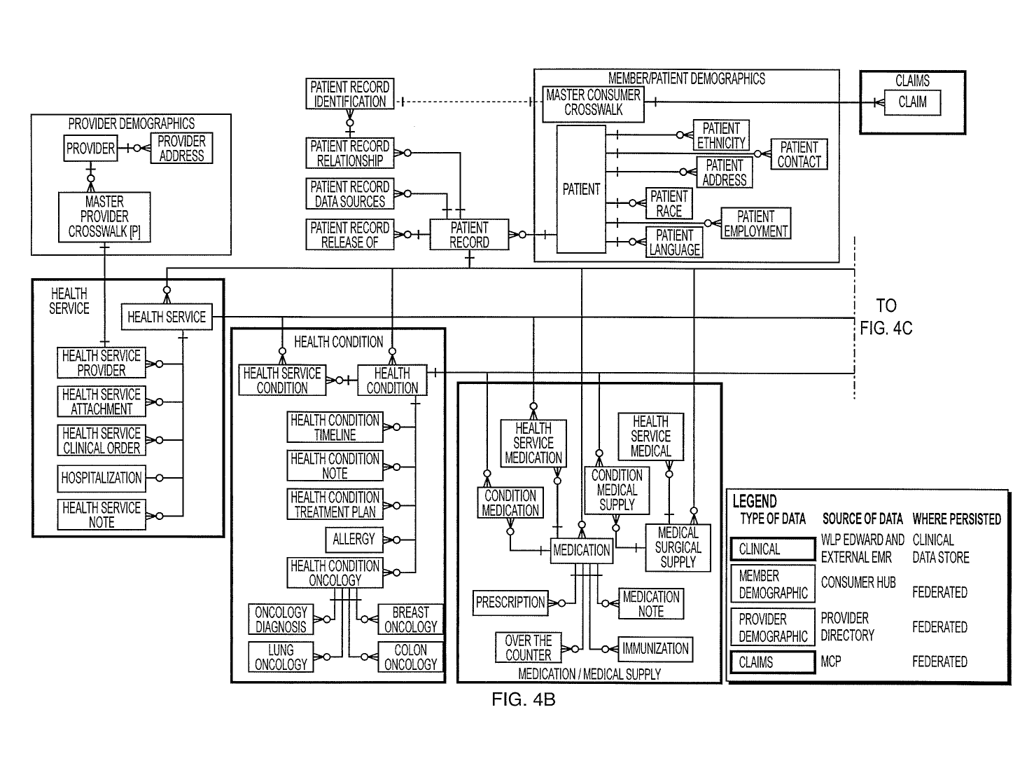

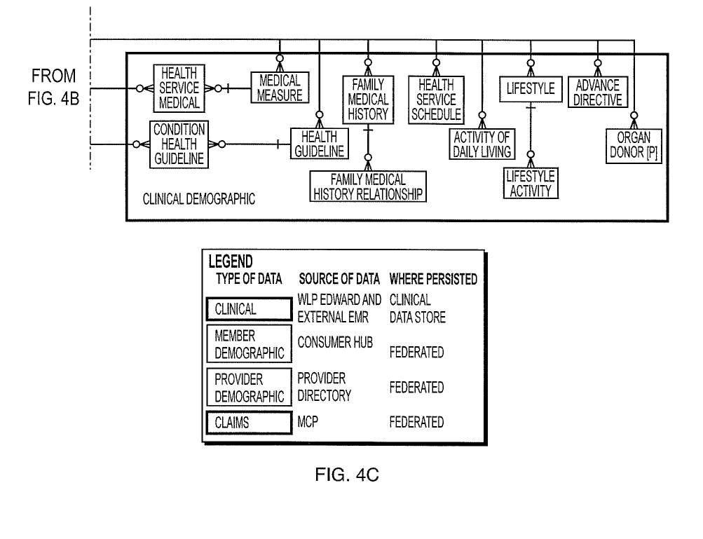

Then, data in the record is then parsed, normalized, and mapped in accordance with an ontology, employing one or more dictionaries, as described below in more detail with regard to FIGS. 3A, 3B and 3C, by translation engine 206. Libraries contain one or more dictionaries that are under specific domains. Each domain could refer to a single medical condition or group of conditions which are inter-related. While in one embodiment, translation engine 206 is part of computer system 204, in other embodiments (shown in FIG. 2), a federated model is employed. In the federated model, data is extracted from persistent storage 207, processed by translation engine 206 as described below, and stored in accordance with a logical model (e.g., see FIGS. 4A and 4B).

Translation engine 206 evaluates the data in persistent storage 207 for inclusion rules, based on the structured ontology that is defined for each known condition or illness a patient may suffer from or be connected to. For example, the normalized source system data is evaluated against rules defined in the system. If the event contains data that matches the triggering criteria defined in a rule, the rule will evaluate the data. The outcome of a rule is either the generation of additional data to be included in the patient record and/or an action (e.g., Enrollment in a Disease Management group, send a message to a provider, etc.) or an audit entry that indicates that a rule was evaluated but not found to be true. Rules are used to update an individual's health status, for health and disease management monitoring, the creation of various alerts and reminders, performance indicator monitoring (e.g., Pay for Performance), and content delivery, among other things.

The patient record, in the exemplary embodiment, includes the following elements that constitute an individual's health record: conditions, services, results, products, and care relationships, by way of example. Conditions may include problems, medical history, family history, allergies, findings (i.e., signs and symptoms) and health status. Health Services may include a timeline list of the healthcare events related to the individual. Health Products may include medications, monitoring and assistive devices and medical supplies used. Thus, significant data about an individual's health as needed for ongoing care is represented by one or more of these elements and the relationships between them.

The system infrastructure can be accessed by an end user 208 without using any screens and user interfaces by employing Interaction Web Services or message-based Communication Services. The system can also be configured to deliver a wide range of visible user services and presentations depending on the type of user 208, the health status of the individual being cared for, and the task in hand. The following are examples of how the patient record can be personalized to both the type of user and the applicable health care knowledge: summary presentations giving an overall picture of the individual's health status, care, and future plans and needs, for use by clinicians and for use by the individual; detailed presentations allowing a closer look at the same record but organized by disease, treatment, or other dimension; and active management of care, the application and personalization of rules and protocols of care across providers and in real-time with alerts and reminders to both clinicians and individuals and their disease/health managers if involved.

Some of the data provided by the administrative and clinical systems may be extracted in real-time and stored in the patient record with minimal latency. For example, post discharge information from the hospitals is available real time and can be directly loaded into patient record. However, certain data (e.g., Lab data) may only be available on a batch basis (e.g., daily, weekly) and is loaded into the patient record accordingly. All the data from in the patient record is, preferably, accessible on a real time basis through services. These services can be web enabled or message based similar to a subscribe and publish model where the systems are direct connected and are listening for new messages or events to pick up and process. The real-time integration is supported by three main system components, in one embodiment, which enable the message or event based data to be streamed to the record with minimal latency, thereby ensuring the timeliness of the data. First, a Router is used as a gateway to the Enterprise Service Bus which hands off the message to the appropriate processing component or Router based on URI for the request. The next internal router in the system provides mediation services, i.e., message validation, message transformation, routing and the connectivity to the service providers, which continually processes new incoming or streamed messages. The Dispatcher is an additional component which retrieves configuration data as XML files and program logic as XSL files from a central location through an HTTP server. Between these three components messages and events are transported to the record via minimal delay due to their dedicated role in the system. A batch interface may also be available for accessing data from the patient record.

Exemplary methods of one embodiment of the present invention are described with reference to FIGS. 3A, 3B and 3C.

Data relating to a patient's health is received from one or more information sources, in step 301. The data may include unstructured data and structured data elements. The unstructured data is parsed to identify data elements in step 302, using one or more dictionaries. The unstructured data may be textual data or other unstructured data such as a data string. The parsing involves, by way of example, comparing terms to the dictionaries to identify matching patters; identifying and extracting acronyms and identifying the meaning of those acronyms; identifying and extracting key terms for a given disease, condition, or treatment and their associated meanings; identifying and extracting dates; and identifying and extracting names. The dictionaries are sources of health information, including custom created dictionaries that include the terminology associated with diagnoses and treatment of various diseases and conditions, synonym dictionaries, lexical dictionaries, and stop word dictionaries. Through this parsing process, unstructured clinical data is converted into a structured format suitable for data mining and algorithm use.

At least some of the structured data elements and at least some of the data elements parsed from the unstructured data are normalized to create normalized data elements in step 303. The normalized data elements may include, in some embodiments, normalized diagnostic codes; normalized clinical terms; and/or normalized units of measure. Thus, for example, the system may support a variety of different coding standards for data, including the following examples: CAQH Council for Affordable Quality Healthcare Provider Datasource; CPT4; FDB—First data Bank Drug Codes; HCPCS—Healthcare Common Procedure Coding System; ICD-9-CM International Classification of Diseases and Procedures; ICD-10-CM International Classification of Diseases and Procedures; LOINC—Logical Observation identifiers, Names and Codes; MediSpan—Drug Codes; MESH—Medical Subject Headings; NCPDP—National Council for Prescription Drugs Program; NDC—National Drug Code; Provider Taxonomy; RxNorm—Nomenclature of Medicine; SNOMED; UMLS—Unified Medical Language System. The system will accept data coded in these exemplary manners and normalize them to a common coding scheme. For example, a lab result data element collected from the physician's electronic medical record, from the lab system itself, from claims information in payor's data warehouse should be represented in the same way from a coding perspective in the patient record. With regard to units of measure, for example, the system will take all English units of measure and convert them to metric. Using the dictionaries, clinical terms are also normalized (e.g., the terms “heart attack” and “myocardial infarction” would be given the same meaning). Through the normalization process, data that is the same but represented differently upon entering the system is converted to a common format and terminology.

The normalized data elements are assigned a weighting step 304. The weightings may be based on an identity of information source; a mechanism for transmission of the received data; passage of time between when the received data is originated and when the received data is received; and/or relevance to another ontology, by way of example. Thus, for example, some sources of information may be inherently reliable in terms of the accuracy and consistency of their data, while others may not. By way of particular example, demographic or coverage data transmitted by an insurance company/payor of the patient would be considered very reliable. Lab results coming from a laboratory facility would be very reliable, whereas diagnostic information coming from this source would not be considered as reliable. Diagnostic information coming from a physician, however, would be considered very reliable.

Exemplary weightings are shown in the below Table 1:

TABLE 1

| Weightage | Data Types | | | | | | |
|---|---|---|---|---|---|---|---|
| Data Sources | Eligibility | Demographic | Lab | Claims | Pharmacy | Clinical Data | Wellness |
| Insurance Payor | 100 | 100 | 70 | 100 | 50 | 0 | 50 |
| EMR System | 0 | 90 | 50 | 50 | 50 | 100 | 0 |
| HIE | 0 | 80 | 50 | 40 | 50 | 90 | 0 |
| Lab Vendor | 0 | 0 | 100 | 0 | 0 | 50 | 0 |
| PBM | 0 | 0 | 0 | 0 | 100 | 0 | 0 |
| Wellness Vendor | 0 | 70 | 0 | 0 | 0 | 20 | 100 |

Further, for example, data reflecting test results from a test just performed will be weighted more heavily than clinician notes taken a month previously. By way of further example, the term “mastectomy” may be heavily weighted in the Breast Cancer domain, as this term has little if any relevance to other domains. In contrast, the term “tumor” will not carry a heavy weighting in the Breast Cancer domain, given is relevance to many other domains, including non-cancer domains.

The normalized data elements are mapped in accordance with an ontology in step 305. As described above, ontology refers to terms that are related to one another based on a domain. Thus, for example, a domain may be Breast Cancer, which includes a number of different terms, including medical terms, layperson terms, surgical procedures etc. Some terms may be uniquely or most commonly associated with a particular domain (e.g., mastectomy). Other terms may regularly be associated with multiple domains (e.g., tumor). Exemplary ontologies are shown in FIGS. 1A and 1B. In some embodiments, the mapping is performed by consulting dictionaries, based on the ontology.

The mapped data is stored in a data repository in accordance with a data model, in step 306. The data model associates the patient to a patient record. The patient record includes data describing third parties associated with providing healthcare for the patient; health condition information of the patient, including health condition timeline information for the patient; medication information for the patient; lifestyle information for the patient; health service information for the patient; health encounter information for the patient; and medical measure data for the patient.

Two representations of an exemplary data model are shown in FIGS. 4A and 4B. To illustrate the manner in which the data model can be used to relate various health information for a patient, with reference to FIG. 4A, consider an example in which Patient 1 has Osteo Arthritis and has also dislocated his toe. HEALTH CONDITIONS are related to MEDICATIONS and SUPPLIES. Patient 1 is taking Prednisone for his Osteo Arthritis; he was given a prefab walking boot and walker for his dislocated toe. HEALTH CONDITIONS are related to GUIDELINES. Patient 1 requires education for his Osteo condition. HEALTH SERVICES are related to MEDICATIONS and SUPPLIES. Patient l′s medications are prescribed during office visits. HEALTH SERVICES are related to CONDITIONS. Patient 1 received a knee x-ray and therapy for his Osteo condition. HEALTH SERVICES are related to MEDICAL MEASURES. Patient 1 has physical exams to monitor his arthritis.

Mapping the data in this manner allows for rationalizing to a single clinical event from multiple, potentially duplicative clinical data elements (potentially having varying formats or clinical meaning). Duplicity is thereby eliminated by applying the ontology to group/organize clinical data around clinical events and/or by applying rules to clinical data to group the data around clinical events. Thus, referring to the lab result data example above, data relating to the lab result should appear only once in the patient record (i.e., not three times from the physician's electronic medical record, from the lab itself and from the payor's claims records).

With reference to FIG. 3B, some embodiments of the invention further include, in step 311, receiving data reflecting a health service, health encounter or health condition of the patient; and, in step 308, determining a diagnosis or proposed course of action based on the received data and the data stored in accordance with the data model.

In some embodiments, upon determining the diagnosis or the proposed course of action, in step 308, it is determined (in step 309) if the dictionaries need to be updated and, if so, in step 310, the dictionaries are updated with content reflecting the diagnosis or the proposed course of action, thereby enriching those sources of information.

With reference to FIG. 3C, some embodiments of the invention include, in step 311, receiving data reflecting a plurality of health services performed for the patient; and, in step 312 determining whether any of the plurality of health services are associated with a same health condition of the patient based on the data stored in accordance with the data model. Thus, for example, if a patient has been diagnosed with cancer, and information regarding that health condition is included in the patient record, if the patient has a test, the system determines whether the test is related to the existing health condition (i.e., cancer) or whether it relates to a different, and perhaps previously unknown to the patient's record, health condition. If related to the cancer, the test data will be associated with that condition in the patient record. If unrelated to the cancer, the test data will be associated with another existing entry in the patient record, or a new entry in the patient record will be established.

Still other embodiments of the invention include, in step 313 (referring back to FIG. 3A) determining a time sequence in which each of the plurality of health services was performed based on the patient record, by picking out dates or other indicators of time sequence. Thus, It is important to know when diagnoses have been made, tests have been performed, and when treatments have been provided.

The following example involves receipt of a consultation note for a patient who has had a history of breast cancer and has been previously treated with radiotherapy. On imaging, an abnormality is found in the right mammogram.

The notes from the physician's electronic medical record system reflect: T1b, N0, M0, ER/PR+, infiltrating ductal carcinoma of the right breast diagnosed 1992 treated with lumpectomy, radiotherapy. Now T1b, NX, M0, ER/PR+, HER-2/neu negative infiltrating ductal carcinoma of the right breast treated with mastectomy Dec. 17, 2010.

The consult physician's follow-up notes reflect: I've been asked by Dr. Smith to evaluate regarding adjuvant TX in her newly diagnosed breast cancer. She was diagnosed with T1C, N0, weakly ER+ and Her-2/neu unknown invasive ductal carcinoma of the right breast in 1992. She was treated with breast conservation therapy, lumpectomy, and radiotherapy. On imaging she now has an abnormality within the right mammogram, a nodular density in the right breast suspicious for malignancy. Biopsy was performed. It's invasive ductal carcinoma, predicted histologic Grade II, ER+/PR+ and Her-2/neu negative. Given that she has previously had radiation therapy only option for management local control of this cancer would be mastectomy. This was performed with immediate reconstruction on Dec. 17, 2010. Pathology revealed invasive ductal cancer, 7 mm in maximal dimension. It was present as a single focus. An in-situ component was not identified. Tumor was ER+/PR+ and Her-2/neu negative. There was no angiolymphatic invasion. No skin or nipple involvement. Right breast axilla, non-sentinel lymph node excision was negative for any nodal tissue. She also had a left reduction mammoplasty which was negative for any evidence of invasive or in-situ cancer.

In the case of the unstructured note, the format of the message must be understood before any formatting changes can be made. The system determines that it is a component of the patient visit, defines it as an unstructured text message and proceeds to parse and normalize the content. Translation engine 206 (of FIG. 2) consults the dictionaries to parse the data in the note, and then normalize the data. Once the data is parsed and normalized, key information is identified from the report. The key information is then converted to a consistent information set by identifying which set of vocabularies to use for the procedure in question.

Thus, for example, the system includes dictionaries and rules to detect the stage of the cancer (T1b, N0, M0) based on Tumor Node Metastasis (TNM) measurement system. The system also relies on dictionaries and rules to detect the Receptor status, including spelled out terms (estrogen receptor/progestin receptor positive, for example) or acronyms (ER/PR+, for example). Another set of rules may be used, e.g., to detect a problem annotation surrounded (in any order) by tumor staging information, receptor information, dates, and treatment information. Other rules may be used in connection with the present invention.

Then, the semantic ontology is employed (in this case, the Breast Cancer ontology) to create a consistent information set by identifying which set of vocabularies to use (i.e., the ontology provides a map of how to traverse the dictionaries). In this example:
Vocabularies:
Unique List

infiltrating ductal carcinoma

right breast

lumpectomy, radiotherapy

Negative

nodular density

Mammoplasty

angiolymphatic

maximal dimension
Staging:

T1b, NX, M0, ER/PR+, HER-2/neu negative
Histology:

infiltrating ductal carcinoma
Timeline:

1992

2010
Duplication:

infiltrating ductal carcinoma

right breast

lumpectomy, radiotherapy

Negative

nodular density

mammoplasty

The above information reflects: Current Breast Cancer Patient who was seen in 2010 with history of prior treatment in 1992 who had a left reduction Mammoplasty which was negative for any evidence of invasive or in-situ cancer.

An entry is then created and stored as part of the patient's record, as follows:
Current HPI

Diagnosis: she now has an abnormality within the right mammogram, a nodular density in the right breast suspicious for malignancy

Date of Diagnosis: 2010

T: T1b

N:NX

M:M0

Histology: infiltrating ductal carcinoma

Location: Right Breast

ER/PR Status: ER/PR+

HER Status: HER-2/neu negative

Surgery: mastectomy

Therapy: radiotherapy
Historical HPI

Diagnosis: Patient has Breast Cancer

Date of Diagnosis: 1992

T:T1b

N:NX

M:M0

Histology: infiltrating ductal carcinoma

Location: Left Breast

ER/PR Status: ER/PR+

HER Status: Unknown

Surgery: lumpectomy

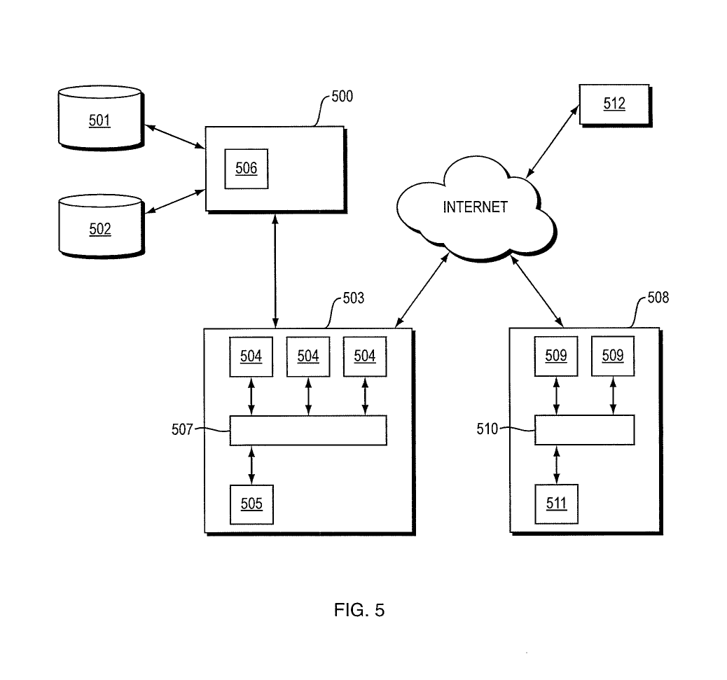

The exemplary system described generally with reference to FIG. 2 comprises a number of different hardware and software components. Exemplary hardware and software that can be employed in connection with that system are now generally described with reference to FIG. 5. Database server(s) 500 may include a database services management application 506 that manages storage and retrieval of data from the database(s) 501, 502. The databases may be relational databases; however, other data organizational structure may be used without departing from the scope of the present invention. One or more application server(s) 503 are in communication with the database server 500. The application server 503 communicates requests for data to the database server 500. The database server 500 retrieves the requested data. The application server 503 may also send data to the database server for storage in the database(s) 501, 502. The application server 503 comprises one or more processors 504, computer readable storage media 505 that store programs (computer readable instructions) for execution by the processor(s), and an interface 507 between the processor(s) 504 and computer readable storage media 505. The application server may store the computer programs referred to herein.

To the extent data and information is communicated over the Internet, one or more Internet servers 508 may be employed. The Internet server 508 also comprises one or more processors 509, computer readable storage media 511 that store programs (computer readable instructions) for execution by the processor(s) 509, and an interface 510 between the processor(s) 509 and computer readable storage media 511. The Internet server 508 is employed to deliver content that can be accessed through the communications network. When data is requested through an application, such as an Internet browser, the Internet server 508 receives and processes the request. The Internet server 508 sends the data or application requested along with user interface instructions for displaying a user interface.

The computers referenced herein are specially programmed, in accordance with the described algorithms, to perform the functionality described herein, such as the software modules integration engine 204 and translation engine 205 of FIG. 2.

The non-transitory computer readable storage media that store the programs (i.e., software modules comprising computer readable instructions) may include volatile and non-volatile, removable and non-removable media implemented in any method or technology for storage of information such as computer-readable instructions, data structures, program modules, or other data. Computer readable storage media may include, but is not limited to, RAM, ROM, Erasable Programmable ROM (EPROM), Electrically Erasable Programmable ROM (EEPROM), flash memory or other solid state memory technology, CD-ROM, digital versatile disks (DVD), or other optical storage, magnetic cassettes, magnetic tape, magnetic disk storage or other magnetic storage devices, or any other medium which can be used to store the desired information and which can be accessed by the computer system and processed using a processor.

What is claimed is:

1. A computer implemented method comprising:
receiving data relating to a patient's health from one or more information sources, the data comprising unstructured data and structured data elements;
parsing the unstructured data, using one or more dictionaries, to identify data elements;
normalizing at least some of the structured data elements and at least some of the data elements parsed from the unstructured data to create normalized data elements;
assigning a weight to the normalized data elements;
mapping the normalized data elements in accordance with an ontology; and
storing the mapped data in a data repository in accordance with a data model,
wherein the data model associates the patient to a patient record, the patient record describing one or more third parties associated with providing healthcare for the patient; health condition information of the patient, including health condition timeline information for the patient; medication information for the patient; lifestyle information for the patient; health service information for the patient; health encounter information for the patient; and medical measure data for the patient.

2. The method of claim 1, further comprising:
receiving data reflecting a health service, health encounter or health condition of the patient; and
determining a diagnosis or proposed course of action based on the data reflecting the health service, health encounter or health condition of the patient and the data stored in accordance with the data model.

3. The method of claim 1 further comprising:
receiving data reflecting a plurality of health services performed for the patient; and
determining whether any of the plurality of health services are associated with a same health condition of the patient based on the data stored in accordance with the data model.

4. The method of claim 3 further comprising:
determining a time sequence in which each of the plurality of health services was performed based on the patient record.

5. The method of claim 2 wherein the mapping is performed using one or more dictionaries, and wherein, upon determining the diagnosis or the proposed course of action, the one or more dictionaries are updated with content reflecting the diagnosis or the proposed course of action.

6. The method of claim 1, wherein there normalized data elements comprise normalized diagnostic codes.

7. The method of claim 1, wherein there normalized data elements comprise normalized clinical terms.

8. The method of claim 1, wherein there normalized data elements comprise normalized units of measure.

9. The method of claim 1, wherein the weightings are based on an identity of information source.

10. The method of claim 1, wherein the weightings are based on passage of time between when the received data is originated and when the received data is received.

11. The method of claim 1, wherein the weightings are based on relevance of to another ontology.

12. A non-transitory computer-readable storage medium that stores instructions which, when executed by one or more processors, cause the one or more processors to perform a method comprising:
receiving data relating to a patient's health from one or more information sources, the data comprising unstructured data and structured data elements;
parsing the unstructured data, using one or more dictionaries, to identify data elements;
normalizing at least some of the structured data elements and at least some of the data elements parsed from the unstructured data to create normalized data elements;
assigning a weight to the normalized data elements mapping the normalized data elements in accordance with an ontology; and
storing the mapped data in a data repository in accordance with a data model,
wherein the data model associates the patient to a patient record, the patient record describing one or more third parties associated with providing healthcare for the patient; health condition information of the patient, including health condition timeline information for the patient; medication information for the patient; lifestyle information for the patient; health service information for the patient; health encounter information for the patient; and medical measure data for the patient.

13. The non-transitory computer-readable storage medium of claim 12, the method further comprising:
receiving data reflecting a health service, health encounter or health condition of the patient; and
determining a diagnosis or proposed course of action based on the data reflecting the health service, health encounter or health condition of the patient and the data stored in accordance with the data model.

14. The non-transitory computer-readable storage medium of claim 12, the method further comprising:
receiving data reflecting a plurality of health services performed for the patient; and
determining whether any of the plurality of health services are associated with a same health condition of the patient based on the data stored in accordance with the data model.

15. The non-transitory computer-readable storage medium of claim 14, the method further comprising:
determining a time sequence in which each of the plurality of health services was performed based on the patient record.

16. The non-transitory computer-readable storage medium of claim 13 wherein the mapping is performed using the one or more dictionaries, and wherein, upon determining the diagnosis or the proposed course of action, the one or more dictionaries are updated with content reflecting the diagnosis or the proposed course of action.

17. The non-transitory computer-readable storage medium of claim 12, wherein there normalized data elements comprise normalized diagnostic codes.

18. The non-transitory computer-readable storage medium of claim 12, wherein there normalized data elements comprise normalized clinical terms.

19. The non-transitory computer-readable storage medium of claim 12, wherein there normalized data elements comprise normalized units of measure.

20. The non-transitory computer-readable storage medium of claim 12, wherein the weightings are based on an identity of information source.

21. The non-transitory computer-readable storage medium of claim 12, wherein the weightings are based on passage of time between when the received data is originated and when the received data is received.

22. The non-transitory computer-readable storage medium of claim 12, wherein the weightings are based on relevance of to another ontology.

23. A system comprising:
memory operable to store at least one program; and
at least one processor communicatively coupled to the memory, in which the at least one program, when executed by the at least one processor, causes the at least one processor to:
receive data relating to a patient's health from one or more information sources, the data comprising unstructured data and structured data elements;
parse the unstructured data, using one or more dictionaries, to identify data elements;
normalize at least some of the structured data elements and at least some of the data elements parsed from the unstructured data to create normalized data elements;
assign a weight to the normalized data elements
map the normalized data elements in accordance with an ontology; and
store the mapped data in a data repository in accordance with a data model,
wherein the data model associates the patient to a patient record, the patient record describing one or more third parties associated with providing healthcare for the patient; health condition information of the patient, including health condition timeline information for the patient; medication information for the patient; lifestyle information for the patient; health service information for the patient; health encounter information for the patient; and medical measure data for the patient.

24. The system of claim 23, wherein the processor further:
receives data reflecting a health service, health encounter or health condition of the patient; and
determines a diagnosis or proposed course of action based on the data reflecting the health service, health encounter or health condition of the patient and the data stored in accordance with the data model.

25. The system of claim 23, wherein the processor further:
receives data reflecting a plurality of health services performed for the patient; and
determines whether any of the plurality of health services are associated with a same health condition of the patient based on the data stored in accordance with the data model.

26. The system of claim 23, wherein the processor further:
determines a time sequence in which each of the plurality of health services was performed based on the patient record.

27. The system of claim 24 wherein the mapping is performed using the one or more dictionaries, and wherein, upon determining the diagnosis or the proposed course of action, the one or more dictionaries are updated with content reflecting the diagnosis or the proposed course of action.

28. The system of claim 23, wherein there normalized data elements comprise normalized diagnostic codes.

29. The system of claim 23, wherein there normalized data elements comprise normalized clinical terms.

30. The system of claim 23, wherein there normalized data elements comprise normalized units of measure.

31. The system of claim 23, wherein the weightings are based on an identity of information source.

32. The system of claim 23, wherein the weightings are based on passage of time between when the received data is originated and when the received data is received.

33. The system of claim 23, wherein the weightings are based on relevance of to another ontology.
